(19) United States
(12) Patent Application Publication
(10) Pub. No.: US 2006/0226807 A1
(43) Pub. Date: Oct. 12, 2006

(54) Method and apparatus for maximizing battery charge

(76) Inventors: Russell L. Simpson, Miami, FL (US); Joseph Patino, Pembroke Pines, FL (US)

Correspondence Address: MOTOROLA, INC., LAW DEPARTMENT, 1303 E. ALGONQUIN ROAD, SCHAUMBURG, IL, 60196, US

(21) Appl. No.: 11/093,630

(22) Filed: Mar. 30, 2005

(51) Int. Cl. H02J 7/00

(52) U.S. Cl. 320/110

(57) ABSTRACT

A device (100) comprises a charging system (102) supplying a source voltage and a source current to one or more battery cells (104). The device operates according to a method 200-300 including the steps of tracking (202) when a user removes a charger from the charging system, determining (204-212) a charging profile from the tracking step, and applying (300-312) the charging profile to the charging system to maximize charging of the one or more battery cells.

### FIELD OF THE INVENTION

This invention relates generally to battery charging systems, and more particularly to a method and apparatus for maximizing battery charge.

### BACKGROUND OF THE INVENTION

A large percentage of cell phone users attach their phone to a charger before bed, and remove the phone from the charger in the morning. When attached to the charger, the battery is charged to full capacity, but over time the battery discharges to some degree and either no further charging occurs so that the battery is not fully charged, or charging resumes until the battery again reaches full capacity. This cycle may occur several times during the night. If the user happens to remove the phone from the charger just after a recharge cycle, the battery will likely be fully charged. On the other hand, if the user removes the phone just before a recharge cycle, the battery will not be fully charged, and may be as low as 80% charged. This problem is also apparent in other battery-operated devices.

### SUMMARY OF THE INVENTION

Embodiments in accordance with the invention provide a method and apparatus for maximizing battery charge.

In a first embodiment of the present invention, a device comprises a charging system supplying a source voltage and a source current to one or more battery cells. The device operates according to a method including the steps of tracking when a user removes a charger from the charging system, determining a charging profile from the tracking step, and applying the charging profile to the charging system to maximize charging of the one or more battery cells.

In a second embodiment of the present invention, a device has a computer-readable storage medium having computer instructions for tracking when a user removes a charger from the charging system, determining a charging profile from the tracking step, and applying the charging profile to a charging system of the device to maximize charging of one or more battery cells coupled to the charging system.

In a third embodiment of the present invention, a device has a charging system for supplying a source voltage and a source current to one or more battery cells, and a processor for controlling functions of the charging system. The processor is programmed to track when a user removes a charger from the charging system, determine a charging profile from the track step, and apply the charging profile to a charging system of the device to maximize charging of one or more battery cells coupled to the charging system.

### BRIEF DESCRIPTION OF THE DRAWINGS

FIG. 1 is a block diagram of a device in accordance with an embodiment of the present invention; and

FIGS. 2-3 are flowcharts depicting methods operating in the device for charging batteries in accordance with an embodiment of the present invention.

### DETAILED DESCRIPTION

While the specification concludes with claims defining the features of embodiments of the invention that are regarded as novel, it is believed that the embodiments of the invention will be better understood from a consideration of the following description in conjunction with the figures, in which like reference numerals are carried forward.

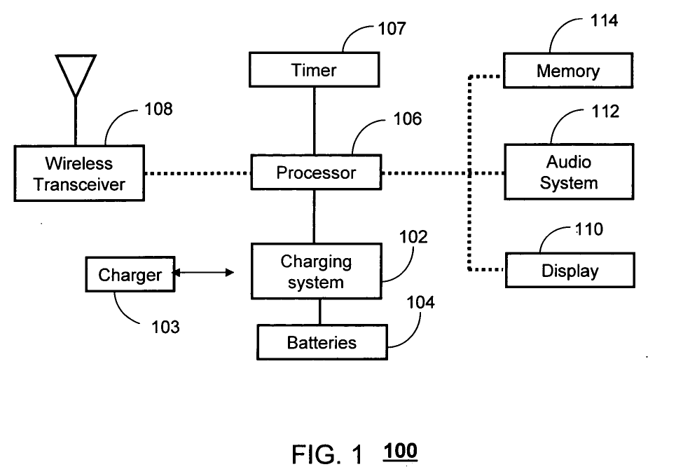

FIG. 1 is a block diagram of a device 100 in accordance with an embodiment of the present invention. The device 100 comprises a charging system 102 coupled to one or more batteries 104, a conventional real-time timer 107 for tracking time of day for each day of the week, and a processor 106 coupled to the foregoing components for controlling operations thereof. Alternatively, the real-time timer 107 can be used to track time from an arbitrary reference which is not necessarily synchronized with a conventional calendar. So long as the timer 107 consistently tracks time from a chosen reference, the use of the timer 107 is applicable to the present invention.

The charging system 102 includes, for example, a conventional regulation circuit (not shown) with conventional charge pumps if needed. The charging system 102 is coupled to the cells 104 for supplying an adjustable source voltage and source current for charging said cells 104. To enable charging of the battery cells 104, a conventional charger 103 is coupled to the charging system 102. Once the charger 103 is removed, charging of the battery cells 104 is no longer possible.

In a supplemental embodiment, the device 100 can include a conventional wireless transceiver 108 for exchanging messages with a communication system, a conventional display 110 for conveying interactive images to a user of the device 100, an audio system 112 for conveying audible signals to the user, and a conventional memory 114 for storage. This embodiment can represent, for instance, a cell phone operating according to the present invention.

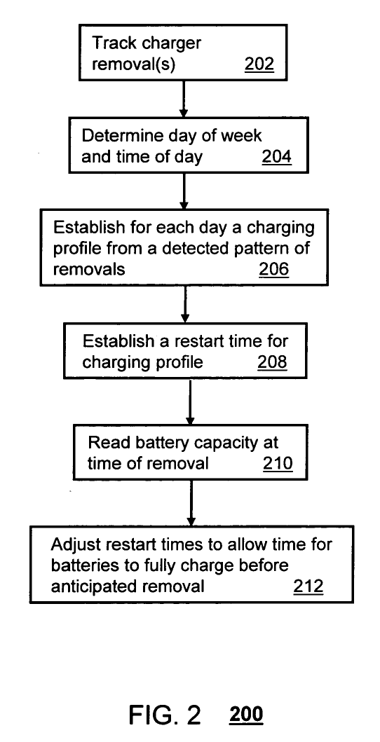

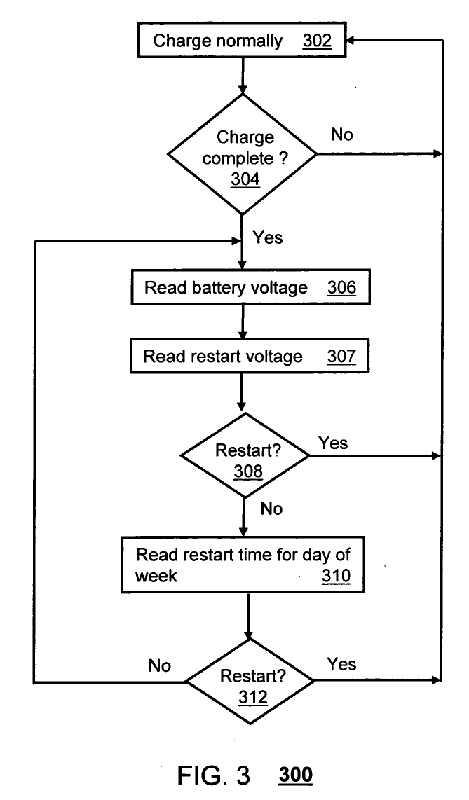

FIGS. 2-3 are flowcharts depicting methods 200-300 operating in the device 100 for charging batteries in accordance with an embodiment of the present invention.

The method 200 begins in step 202 by tracking removal(s) of the charger 103 from the charging system 102. Entry into step 202 can be performed in real-time by detection of a conventional software interrupt triggered by the removal of the charger 103. Alternatively, step 202 can be performed with conventional polling techniques. Upon detecting a removal, in step 204 a day of the week, and time of day is recorded. Alternatively, step 204 can track removals at an arbitrary time reference, which has no relation to a conventional calendar. Thus, a seven day period measured from a chosen reference can provide a time of day, or day of the week, inconsistent with a conventional calendar used in the area where the device 100 is being operated. All that is required by the present invention is for step 204 to track time consistently from a chosen point of reference. The reference can be conventional or arbitrary. For illustration purposes only, methods 200-300 track time according to a conventional calendar.

In step 206, a charging profile is determined from a detected pattern of removals for each day of the week. From each charging profile a restart time is established in step 208. The restart time can be derived from a running average of removals detected each day of the week, or by way of a more sophisticated algorithm involving statistical and probabilistic analysis of the removals tracked in step 202. In step 210 the battery capacity of the battery cells 104 is determined for each time of removal. From the cell capacity readings, a determination can be made for each day of the week as to how much more time would have been needed to charge the battery cells 104 prior to the premature removal. The additional charge times can be used to adjust the restart times of step 208 in step 212 so as to allow time for the one or more battery cells 104 to fully charge before an anticipated removal of the charger 103.

Where there are multiple users of the device 100, method 200 can be repeated for each user of the device 100. This repetition can be selectively chosen per user through, for example, a menu provided in a UI (User Interface) conveyed by the display 110. Accordingly, each user would have a charging profile for each day of the week and corresponding restart times as described in method 200. Method 200 can be further supplemented by providing a means to bypass an active charging profile when a user knows s/he isn't going to follow their normal routine and just wants the device 100 to be charged immediately.

Accordingly, for example, it may be that the charging profile of a particular user of the device 100 shows that the user removes the charger Monday through Friday (M-F) on average at 6 AM and on the weekend at 7:30 AM. Additionally, it may be that the capacity of the batteries 104 at time of removal is determined to be on average 85% from M-F and 95% on weekends. This in turn may lead to an adjusted restart time of 5 AM (one hour before average removal time M-F) and 7 AM (one-half hour before average removal time on weekends). The foregoing example can be applied to each user of the device 100 based on observed behavior per user. Note, each day of the week can have different results than the ones provided above, which were chosen for illustration purposes only. Additionally, less granularity than day-to-day restart times can be used without departing from the scope and spirit of the claims below.

FIG. 3 depicts how method 200 can be used in a method 300 for operating the charging system 102 according to an embodiment of the present invention. Method 300 begins with step 302 where the charging system 102 charges the battery cells 104 with conventional methods (e.g., charge pump, trickle charge, or like methods). In step 304 a determination is made whether the charge cycle is complete. This can be performed by measuring the capacity of the battery cells 104 utilizing conventional techniques such as load current, charge voltage, or like techniques. If the battery cells 104 are not fully charged, then step 302 is repeated. If the battery cells 104 are fully charged, then in steps 306-308 the battery cells 104 are monitored for energy leakage typically experienced by conventional cell technologies such as Nickel Cadmium and Lithium Ion cells, and/or external loading due to the device 100 remaining in operation when coupled to the charger 103 (e.g., a cell phone kept in standby mode while charging). If the voltage of the battery cells 104 read in step 306 drops below a restart voltage threshold read in step 307 (pre-stored, for example, in a non-volatile portion of the memory 114), then at decision block 308 the method 300 proceeds with step 302 where the charge cycle is restarted. In prior art charging systems the restart voltage threshold can typically be at a level where the capacity of the battery cells 104 can drop to 80%.

Thus, if the capacity of the battery cells 104 at decision block 308 is determined to be above the restart voltage threshold, then a removal near the restart voltage can reduce the battery performance of the device 100. To avoid this, method 300 proceeds to steps 310-312 which apply the charging profile(s) of method 200. In these steps, the restart times measured in method 200 can be utilized to anticipate a removal and thereby prevent a below full capacity charge of the battery cells 104. Thus, if in step 310 the time of day is at or after the adjusted restart time of a particular day of the week, a decision block 312 returns the method to step 302 which engages the charging system 102 for recharging the battery cells 104. Otherwise, at decision block 312, steps 306-312 are repeated in whole or in part until such time it is appropriate to recharge the cells 104.

It should be evident to the reader that the present invention can be realized in hardware, software, or a combination of hardware and software. Thus, the present invention can be embedded in a computer program product, which comprises all the features enabling the implementation of the methods described herein, and which when loaded in a computer system is able to carry out these methods as computer instructions. A computer program in the present context means any expression, in any language, code or notation, of a set of instructions intended to cause a system having an information processing capability to perform a particular function either directly or after either or both of the following: a) conversion to another language, code or notation; b) reproduction in a different material form.

It should be also evident that the present invention may be used in many arrangements. Thus, although the description is made for particular arrangements and methods, the intent and concept of the invention is suitable and applicable to other arrangements not described herein. For example, method 200 as described can adjusted to perform a single running average per week, or can perform more granular calculations per day, or can use statistical analysis for more accurate predictions. Any of these modifications to the flow charts of FIGS. 2-3 and corresponding descriptions are within the scope of the present invention. It would be clear therefore to those skilled in the art that modifications to the disclosed embodiments described can be effected without departing from the spirit and scope of the invention.

Accordingly, the described embodiments ought to be construed to be merely illustrative of some of the more prominent features and applications of the invention. It should also be understood that the claims are intended to cover the structures described herein as performing the recited function and not only structural equivalents. Therefore, equivalent structures that read on the description are to be construed to be inclusive of the scope of the invention as defined in the following claims. Thus, reference should be made to the following claims, rather than to the foregoing specification, as indicating the scope of the invention.

What is claimed is:

1. In a device comprising a charging system supplying a source voltage and a source current to one or more battery cells, a method comprising the steps of:
tracking when a user removes a charger from the charging system;
determining a charging profile from the tracking step; and
applying the charging profile to the charging system to maximize charging of the one or more battery cells.

2. The method of claim 1, wherein the charging profile comprises a pattern detected in the tracking step.

3. The method of claim 2, further comprising the step of establishing a restart time from the pattern.

4. The method of claim 2, wherein the step of tracking is performed on a plurality of days of the week.

5. The method of claim 4, further comprising the step of establishing a restart time for each of the plurality of days of the week from the pattern detected in the tracking step.

6. The method of claim 3, further comprising the steps of:
determining the capacity of the one or more battery cells; and
adjusting the restart time to allow time for the one or more battery cells to fully charge before an anticipated removal of the charger.

7. The method of claim 3, wherein the applying step further comprising the steps of:
charging the one or more battery cells when a voltage of said one or more battery cells falls below a restart voltage threshold; and
charging the one or more battery cells at or after the restart time.

8. The method of claim 2, wherein the determining step comprises the step of determining a charging profile for each user of the device, and wherein the applying step comprises the step of applying the charging profile of a current user of the device to the charging system.

9. The method of claim 8, further comprising the step of bypassing an active charging profile of the device upon request of a user of the device.

10. A device having a computer-readable storage medium, comprising computer instructions for:
tracking when a user removes a charger from the charging system;
determining a charging profile from the tracking step; and
applying the charging profile to a charging system of the device to maximize charging of one or more battery cells coupled to the charging system.

11. The storage medium of claim 10, wherein the charging profile comprises a pattern detected in the tracking step.

12. The storage medium of claim 11, further comprising computer instructions for establishing a restart time from the pattern.

13. The storage medium of claim 11, wherein the step of tracking is performed on a plurality of days of the week.

14. The storage medium of claim 13, further comprising computer instructions for establishing a restart time for each of the plurality of days of the week from the pattern detected in the tracking step.

15. The storage medium of claim 12, further comprising computer instructions for:
determining the capacity of the one or more battery cells; and
adjusting the restart time to allow time for the one or more battery cells to fully charge before an anticipated removal of the charger.

16. The storage medium of claim 3, wherein the applying step further comprising computer instructions for:
charging the one or more battery cells when a voltage of said one or more battery cells falls below a restart voltage threshold; and
charging the one or more battery cells the one or more battery cells at or after the restart time.

17. A device, comprising:
a charging system for supplying a source voltage and a source current to one or more battery cells;
a timer; and
a processor for controlling functions of the charging system, wherein the processor is programmed to:
track when a user removes a charger from the charging system;
determine a charging profile from the track step; and
apply the charging profile to a charging system of the device to maximize charging of one or more battery cells coupled to the charging system.

18. The device of claim 17, wherein the charging profile comprises a pattern detected in the tracking step.

19. The device of claim 18, wherein the processor is further programmed to establish a restart time from the pattern.

20. The device of claim 19, further including at least one among a group of components comprising, a wireless transceiver for exchanging messages with a communication system, a display for conveying interactive images to a user of the device, a memory for storage, and an audio system for conveying audible signals to the user, wherein the processor is further programmed to:
determine the capacity of the one or more battery cells; and
adjust the restart time to allow time for the one or more battery cells to fully charge before an anticipated removal of the charger.
